(19) United States
(12) Patent Application Publication
(10) Pub. No.: US 2019/0002265 A1
(43) Pub. Date: Jan. 3, 2019

(54) Cooler

(71) Applicant: William Gaylord Lunney, II, Huntington Beach, CA (US)

(72) Inventor: William Gaylord Lunney, II, Huntington Beach, CA (US)

(21) Appl. No.: 16/018,307

(22) Filed: Jun. 26, 2018

Related U.S. Application Data
(60) Provisional application No. 62/527,977, filed on Jun. 30, 2017.

(51) Int. Cl. B67D 1/08

(52) U.S. Cl. CPC B67D 1/0857; B67D 2001/0095

(57) ABSTRACT

The system may be used to retain and delivery liquid from an interior of a cavity to an exterior thereof. The device may include a housing and a dispenser that is integrated into the housing. The housing may hold one or more storage containers containing a liquid. The dispenser includes a system to translate the fluid from within the storage container to a position exterior of the housing. The system may include nozzles located on an exterior surface of the housing for dispensing liquid from the interior of the storage containers.

### BACKGROUND

Many people typically find carbonated beverages more enjoyable when served chilled rather than when served at room temperature. This preference for chilled carbonated beverages requires many consumers to purchase cans and/or bottles for consumption on the go. Conventionally, these beverages are in a refrigerator at concession stands or other permanently installed location that supports the appropriate electrical requirements to maintain a cooled environment in order to ensure that the beverages stay chilled. However, because refrigerators are not portable, many turn to coolers in order to keep these beverages chilled. Unfortunately, the use of a cooler can be a hindrance, because coolers tend to be bulky and difficult to transport. Coolers also have a limited capacity that still permits them to be portable.

Additionally, many people prefer the taste of certain carbonated beverages from a tap than from a can or bottle. Unfortunately, the infrastructure for dispensing a cooled beverage from a tap is more complicated than simply opening a canned beverage. Therefore, these systems are conventionally structurally formed in stationary locations, such as the concession stands described above.

### SUMMARY

Exemplary embodiments described herein include a cooler with a beverage dispenser. The cooler may be mobile.

In an exemplary embodiment, the cooler may also include a beverage dispenser and be capable of housing one or more containers. For example, the cooler may include a housing and a dispensing assembly. The housing may be configured to reduce heat transfer and maintain a cooled interior environment.

In an exemplary embodiment, the housing may include a dispensing face. The dispensing face may mateably interact with a dispensing assembly. The dispensing assembly may include one or more dispensing nozzles, one or more tubes, and one or more containers. Each of the tubes may connect at least one of the dispensing nozzles to the containers. The containers may house a beverage. The nozzles may be located on an exterior surface of the housing and the containers may be located inside of the housing.

In an exemplary embodiment, the dispensing face may also include a fluid collection portion. The fluid collection portion may be located underneath the nozzles. The fluid collection portion may collect overflow from the dispensing assembly.

In an exemplary embodiment, the containers may house a carbonated beverage. The containers may be pressurized. The system may be configured such that a fluid path is created between an interior of the container, within the interior of the cooler to an exterior of the cooler. The fluid flow path may comprise a valve for selectively dispensing the contained fluid.

In an exemplary embodiment, the cooler may be configured to fit onto the back of an automobile. For example, the cooler may be configured to mate with a truck bed or open portion of the back of a truck or automobile.

### DRAWINGS

FIG. 1 illustrates a perspective view of an exemplary embodiment of a cooler.

FIG. 2a illustrates a rear view of an exemplary embodiment of a cooler.

FIG. 2b illustrates an additional rear view of an exemplary embodiment of a cooler.

FIG. 2c illustrates an additional rear view of an exemplary embodiment of a cooler.

FIG. 3 illustrates an additional perspective view of an exemplary embodiment of a cooler.

FIG. 4 illustrates an additional perspective view of an exemplary embodiment of a cooler.

FIG. 5 illustrates a side view of an exemplary embodiment of a cooler.

FIG. 6 illustrates an additional side view of an exemplary embodiment of a cooler.

FIG. 7 illustrates an additional rear view of an exemplary embodiment of a cooler.

FIG. 8 illustrates an additional rear view of an exemplary embodiment of a cooler.

### DETAILED DESCRIPTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

As used herein, the terms “about,” “substantially,” or “approximately” for any numerical values, ranges, shapes, distances, relative relationships, etc. indicate a suitable dimensional tolerance that allows the part or collection of components to function for its intended purpose as described herein.

Exemplary embodiments described herein include a cooler with a beverage dispenser. In an exemplary embodiment, the cooler may be transportable. Although embodiments described herein are in terms of a dispensing system for carbonated beverages, the disclosure is not so limited but is also applicable to dispensing liquids more generally. The system may be used with any liquid, and may be used with liquids having a temperature different than a temperature outside of the cooler. Although described in terms of a cooler, exemplary embodiments may be any temperature including above or below ambient, or at ambient temperature.

Exemplary embodiments include a cooler having a beverage dispenser and capable of housing one or more containers. In an exemplary embodiment, the cooler may include a housing and a dispensing assembly. A fluid flow path may be defined between an interior of the container and an exterior of the housing.

Exemplary embodiments of the housing may prevent or reduce a temperature change within the housing or prevent or reduce the heat conduction through the housing wall. For example, the housing wall may comprise insulation and be sufficiently thick to limit heat transfer to/from an external environment. In an exemplary embodiment, the wall may include at least two layers of structural material. The two layers may be placed adjacent and overlap or be generally aligned such that a cavity is formed in between faces of the two layers. The cavity may be filed with at least one type of insulating material. The insulating material may be a gas, foam, fiber, porous material, sheet, matrix, or combinations thereof.

In an exemplary embodiment, the housing includes a recess on an exterior lateral side thereof. The recess may include a plurality of nozzles or a plurality of recesses having a single nozzle per recess or a combination thereof. The recess may define a lower ledge for collecting overflow fluid dispensed from the nozzles. The lower ledge may be angled to facilitate flow out off of the ledge. The drainage path may be created by a hole, indentation, projection, contoured surface, tube or hose, and combinations thereof to remove liquid from the lower ledge and away from a dispensing area. The nozzle handles may be within the recess such that the nozzle handles does not extend past an exterior profile of the housing when in a closed position.

In an exemplary embodiment, the dispensing assembly may include one or more dispensing nozzles, one or more tubes, and combinations thereof. Each of the tubes may connect at least one of the dispensing nozzles to a container. The containers may house a beverage and be positioned within an interior cavity of the housing. The nozzles may be located on an exterior surface of the housing and the containers may be located inside of the housing.

In an exemplary embodiment, a side of the housing may include a dispensing face. The dispensing face may mateably interact with the dispensing assembly. The dispensing face may include one or more cutouts or indentations in the housing side. The indentations may be of a sufficient size such that at least one of the dispensing nozzles may protrude outwardly from each of a surface of the indentations and remain within a volume of the indentation or may extend outward out of the volume defined by the indentation. A plurality of dispensing nozzles may be positioned within and protrude outwardly from surface of a single indentations.

In an exemplary embodiment, each of the dispensing nozzles may include a valve. The valve may be biased in a closed position. When the valve is opened, the beverage may travel from the container interior through the tube and out of the dispensing nozzle through the housing wall. The valve may be opened by a method including but not limited to, actuating a lever, knob, button, or any combination thereof.

In an exemplary embodiment, the dispensing face may also include a fluid collection portion. The fluid collection portion may be covered by a grate. The fluid collection portion may be located underneath the nozzles. The fluid collection portion may collect any spills from the dispensing assembly. The fluid collection portion may be defined by a portion of the indentation.

In an exemplary embodiment, the fluid collection portion may be located in a recessed portion of the side of the cooler with the dispensing face. The recessed portion may be a recess within a surface of the indentation. A receptacle may be placed inside of the cooler such that the receptacle may collect any fluid that passes through the fluid collection portion.

In an exemplary embodiment, an interior surface of the sides of the cooler may be substantially waterproof. This may allow for expedient cleaning of the interior of the cooler.

In an exemplary embodiment, an exterior surface of the sides of the cooler may be substantially waterproof.

In an exemplary embodiment, the housing may include an access opening. For example, a side of the housing may include a door. The door may allow a user to enter and/or load the cooler. The door may include, but is not limited to, any of the following: a rolling door, a sliding door, a hinged door, a removable door, or any combination thereof.

In an exemplary embodiment, the housing may be secured onto a back surface of a vehicle. For example, the housing may be configured to mate or approximate a portion of a truck bed. The housing may extend vertically above the truck bed. The housing may include shaped lateral sides that correspond to a ledge defining the perimeter of the truck bed. The exterior width dimension of the housing may therefore be narrower at a lower portion of the housing that at an upper portion of the housing. The exterior dimension of the lower portion of the housing may be approximately constant over a height. The exterior dimension may then transition either step-wise to define a downward facing ledge or gradually to define a continuous outward taper from the lower portion to an upper portion. The exterior dimension of the upper portion of the housing may be approximately constant over a second height. The exterior dimension of the upper portion may be greater than the exterior dimension of the lower portion. The exterior dimension of the upper portion may be generally constant or may taper from a greater dimension at the transition from the lower portion to a smaller dimension at the top of the housing away from the transition portion. The smaller dimension at the top may still be greater or equal to the exterior dimension along the lower portion. The transition portion of the exterior dimension may be configured to mate or rest on a ledge of a truck bed with the lower dimension fitting within the width of the truck bed and the upper portion extending above the volume of the truck bed.

In an exemplary embodiment, the housing is configured to rest within a bed of a truck. In an exemplary embodiment, an outer surface of the housing may be contoured to mate or correspond to features within a truck bed. For example, an exterior of the housing may include indentation to accommodate the projections within a truck bed to define the truck's wheel wheels. The housing may have opposing lateral sides configured to mate with the interior of a truck bed and extend vertically above the truck bed sides. The opposing lateral sides of the housing may include a reduced diameter lower portion for fitting within a truck bed and a greater diameter upper portion. The lower portion may be contoured to correspond to interior features of a truck bed such as wheel wells. A step wise transition may be present between the lower portion and the upper portion such that the step wise transition may rest on a horizontal top edge of the truck bed side wall. The housing may have a generally planar bottom surface configured to rest on a truck bed bottom surface. The housing may have a roof enclosing a space between the bottom surface and the lateral sides. The roof may be positioned at a height approximating the height of the cab of the truck when the housing is positioned in the truck bed.

The housing may support a removable floor panel within the housing cavity. The removable floor panel may permit easy access to objects within the housing by pulling the removable floor panel out and exposing containers positioned on the removable floor panel. The floor panel may also include a covering or other removable surface for easy cleaning. In an exemplary embodiment, the removable floor panel may be configured to slide horizontally outward from an interior of the housing.

In an exemplary embodiment, the interior of the housing may include a retaining system. The retaining system may be configured to reduce or prevent movement of the container(s) within the interior of the housing. For example, exemplary retaining systems may include indentations in the interior surface floor of the housing to position a bottom portion of a container therein. An exemplary retaining system may include straps, harness, fence, gate, or other retaining feature for tethering or securing the container to the housing interior. In an exemplary embodiment, the interior wall of the housing may include a tether such that an elongate feature may be positioned around at least a portion of the container and reduce movement of the container beyond the limitations defined by the elongate feature. The elongate feature may be bungee, belt, straps, elastic chords, etc. The retaining system may be removably coupled to the container such as through clasps, belt buckle, hook and loop fastener, buttons, loop, tie, or otherwise. The interior of the housing may include a plurality of retaining mechanisms for securing a plurality of containers to an interior of the housing. For example, the containers may be secured to a floor of the housing, the removable floor panel, the interior side wall, and combinations thereof. The retaining mechanisms may be mated or contoured surfaces, indentations, clamps, friction fit engaging surfaces, belts, buckles, straps, elastic cords, loops, hook and loop fasteners, and combinations thereof.

In an exemplary embodiment, the containers may be pressurized.

In an exemplary embodiment, the cooler may include a cooling source. The cooling source may cool the cooler. The cooling source may include, but is not limited, to a cold plate system, air refrigeration system, a cooling jacket around each one of the containers, dry ice inside the housing, etc.

The figures illustrate an exemplary embodiment of a cooler. Features described herein may be removed, combined, separated, duplicated, integrated, or otherwise rearranged or recombined and remain within the disclosure of the instant application. The exemplary cooler may include a housing configured to prevent or reduce heat transfer through a wall thereof. For example, the wall may be a double walled insulation. The housing may fully enclose a space. The housing may include an opening or access portion, such as through doors. As illustrated in the figures, the access portion comprises an opening in which double doors cover the opening and provide selectable access to the interior of the housing. The doors may include a lock to ensure the doors remain in a closed configuration.

In an exemplary embodiment, the housing may include a dispensing system. The dispensing system may be configured to create a fluid flow path from an interior of a container positioned within the housing to an exterior of the housing through a housing wall. The container may be separate from and removable from the housing wall. The dispensing system may comprise tubes, valves, nozzles, and combinations thereof. The dispensing system may include a nozzle on the exterior surface of the housing.

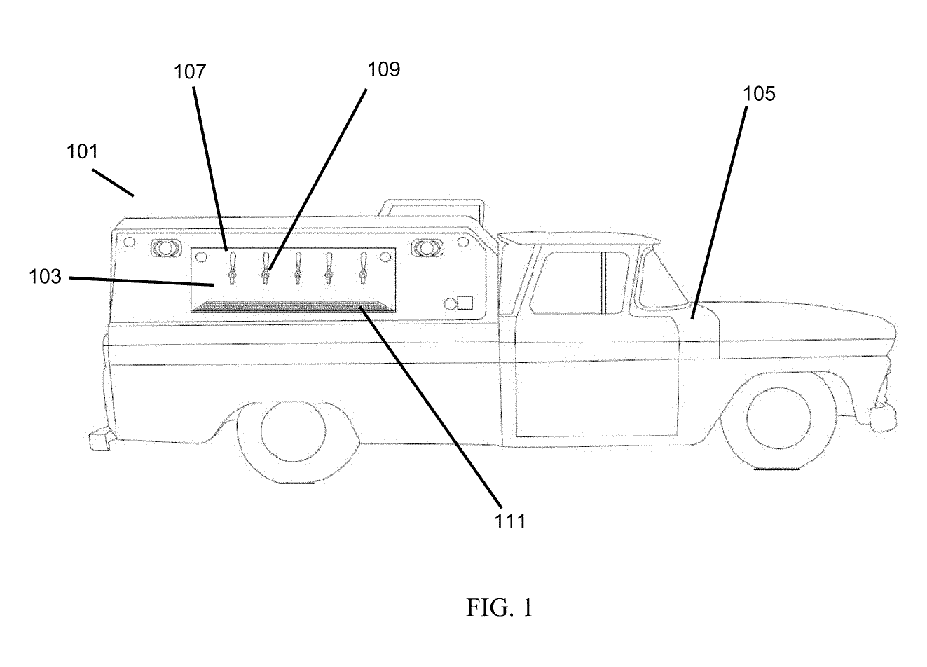

FIG. 1 illustrates a perspective view of an exemplary embodiment of a cooler 101. As shown in FIG. 1, the cooler 101 may include a housing. In an exemplary embodiment, the housing has multiple sides. One of the sides may include a dispensing face 103. The dispensing face may further include one or more nozzles 109, one or more knobs 107, and a fluid collection portion 111. The cooler 101 may be secured to an automobile 105.

As shown in FIG. 1, the nozzles 109 may be located on an exterior surface of the cooler 101. The nozzles 109 may protrude from one or more indentations located on an exterior surface of the cooler. The knobs may be located on top of the nozzles 109. Each of the knobs 107 may control a flow of a beverage from one of the nozzles 109, such that one of the knobs 107 may be pulled or pushed in order to open the corresponding nozzle 109, forcing a beverage out of the nozzle 109. The fluid collection portion 111 may be located sufficiently underneath the nozzles 109. This may allow for the fluid collection portion 111 to collect any errant fluid dispensed from the nozzles 109. The fluid collection portion 111 may be topped with a grate.

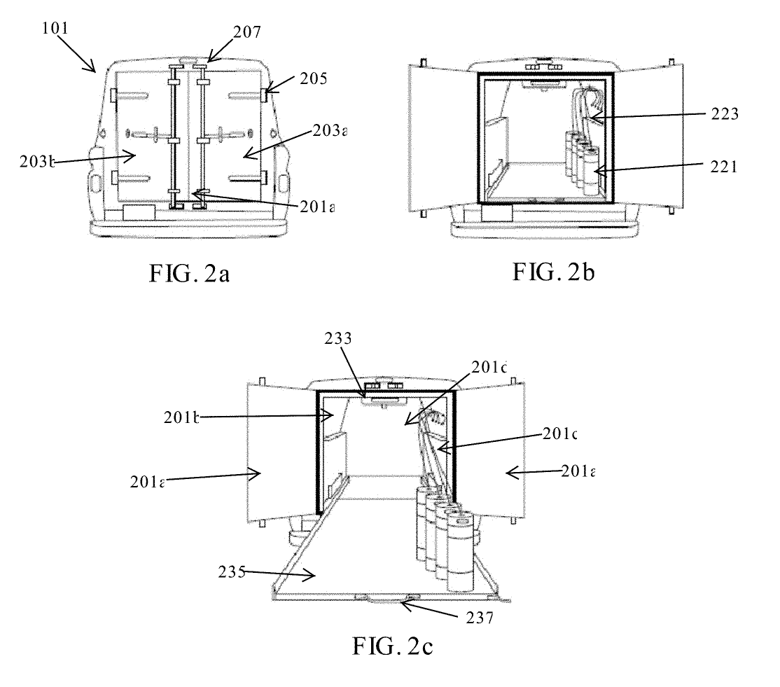

FIG. 2a illustrates a rear view of an exemplary embodiment of a cooler according to embodiments described herein. As shown in FIG. 2a, a back side of the cooler 101 may include a door assembly 201.

As shown in FIG. 2a, the door assembly 201a may include two panels 203a, 203b, one or more hinges 205, and one or more locking mechanisms 207. The panels 203a, 203b may be connected to the housing of the cooler by the hinges 205. The hinges may permit the panels to rotate between a closed configuration and an open configuration. The locking mechanisms 207 may secure the two panels 203a, 203b in the closed configuration. Although two panels are illustrated, the door assembly may also be created from a single panel. Other door assemblies may also be used such as a sliding gate, retractable hinged door, etc.

FIG. 2b illustrates an additional rear view of an exemplary embodiment of a cooler according to embodiments described herein. As shown in FIG. 2b, the cooler 101 may hold one or more containers 221. The containers 221 may be connected to at least one nozzle located on an exterior surface of the cooler (see FIG. 1) by at least one tube 223. The containers 221 may hold a beverage. The beverage may travel from the container 221, through the tube 223, and out through the corresponding nozzle.

FIG. 2c illustrates an additional rear view of an exemplary embodiment of a cooler. As shown in FIG. 2c, the cooler 101 may include a housing to define a fully enclosed interior space. An interior portion of the housing. The housing may include two vertical lateral sized 201b, 201c a top 233, a floor 235, a front 201d and a rear 201a. The rear 201a may define or create a door or access into the interior of the housing. The four walls 201a, 201b, 201c, 201d may be significantly vertically upright. One, two, three or four of the walls may abut a portion of the automobile when the cooler 101 is secured to the automobile 105.

As shown in FIG. 2c, the floor 235 may include a translatable portion that is configured to move a portion of the floor relative to the walls of the housing. The translatable portion may include a surface that overlays a second floor defining the housing and creating the insulated interior cavity. The translatable portion may be configured to slide or extend from an interior position to a position at least partially exterior of the cavity defined by the housing. The translatable portion may move on wheels, tracks, rails, ball bearings, or other mechanism, and combinations thereof. The tracks may be on the floor of the interior cavity and/or may be on an interior surface of a wall of the housing.

As shown in FIG. 2c, the floor 235 may include a handle 237 and one or more rolling mechanisms. The handle 237 may be used to pull the floor 235 out from inside of the cooler 101. The floor 235 may include at least one rolling mechanism on two sides of the floor. Each of the rolling mechanisms may matably interact with the tracks on the walls 201b, 201c or floor such that the floor 235 may be slidably moved, or rolled, out of the cooler 101. The one or more rolling mechanisms may include a stop to prevent or impede further extension of the floor 235 out of the interior cavity such that the floor 235 is prevented or impeded from separating from the cooler.

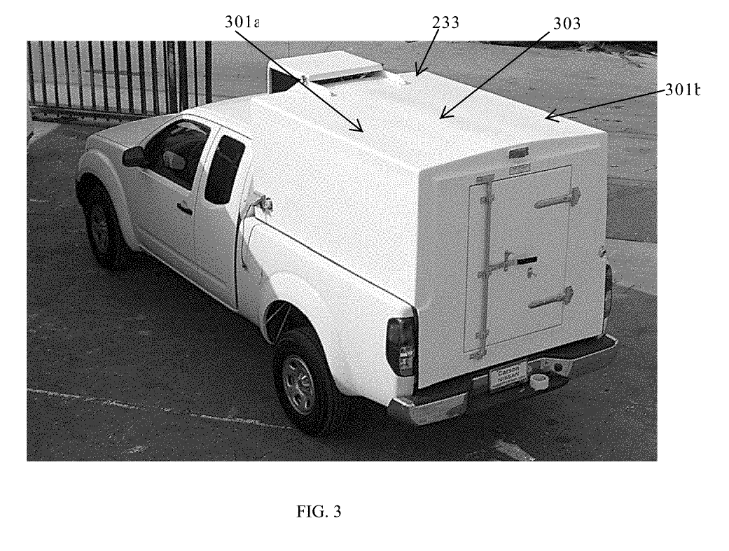

FIG. 3 illustrates a perspective view of an exemplary embodiment of a cooler. As shown in FIG. 3, an exterior top 233 may be sloped, such that exterior lateral sides 301a, 301b adjacent or at the outer perimeter of the housing are lower than an central portion 303 or middle of the top 233. The interior top surface may be similarly concave such that the height of the interior cavity is greatest at a center of the housing than toward a perimeter or adjacent the lateral sides of the housing.

In an exemplary embodiment, the housing may be attached to a truck bed. The housing may be attached through different attachment mechanisms. As shown in FIG. 3, the cooler 101 may be secured to the automobile with cam locking brackets to the side bed or bolts through the box and through the truck bed.

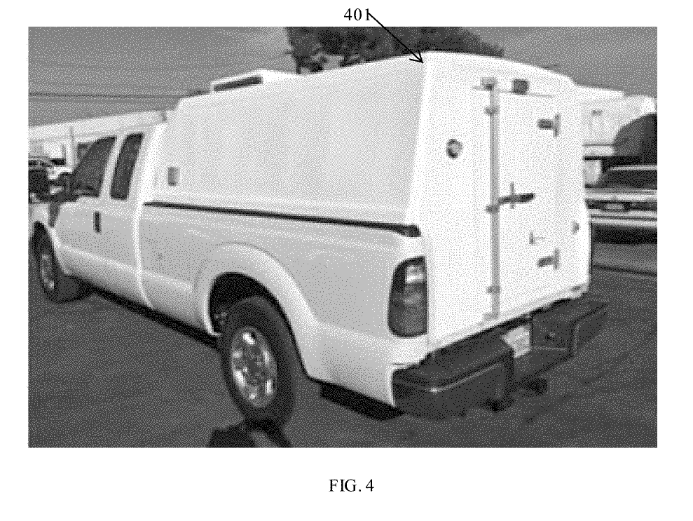

FIG. 4 illustrates an additional perspective view of an exemplary embodiment of a cooler. As shown in FIG. 4, an outer portion of the sides of the cooler may join at an angle 401 greater than 90 degrees. An exterior cross section of the cooler may form a trapezoidal structure.

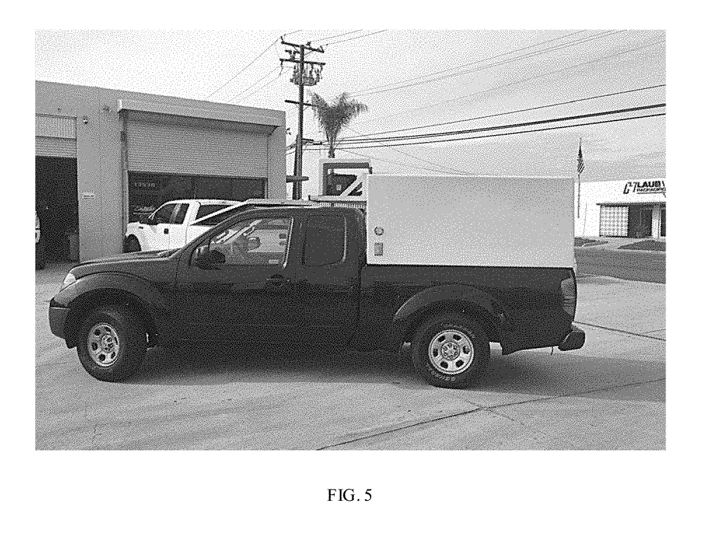

FIG. 5 illustrates a side view of an exemplary embodiment of a cooler according to embodiments described herein.

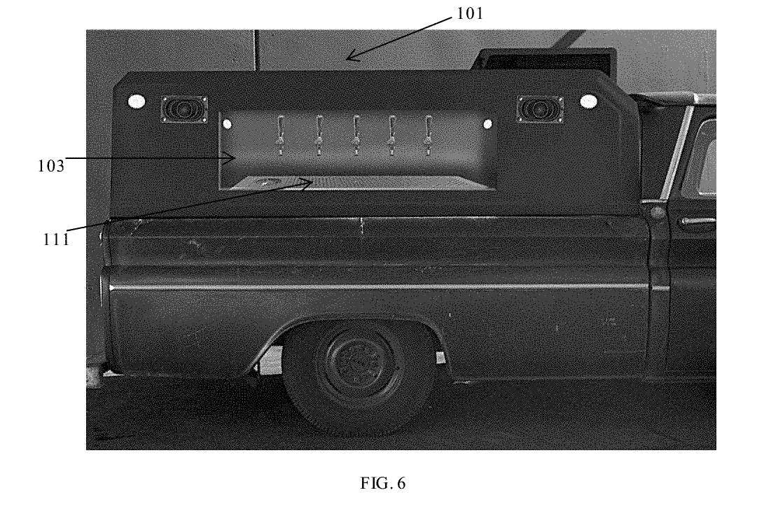

FIG. 6 illustrates an exemplary side view of an exemplary embodiment of a cooler. As shown in FIG. 6, the dispensing face 103 may be located in a recessed portion of the side. This may allow for any errant fluid collected by the fluid collection portion 111 to flow through the grate into a receptacle located inside of the cooler 101.

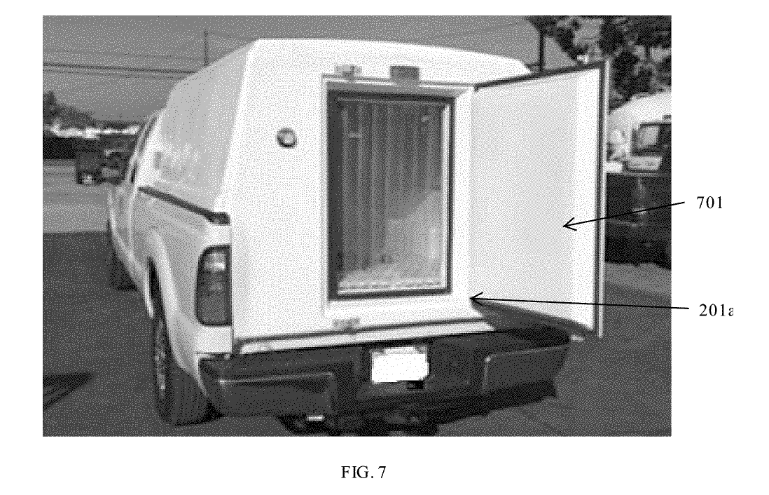

FIG. 7 illustrates an exemplary rear view of an exemplary embodiment of a cooler. As shown in FIG. 7, the door assembly may include only one panel 701. The panel 701 may be connected to the wall 201a by one or more hinges. The door assembly may also include a temperature control system. The temperature control system may reduce air flow from or into the interior cavity even when the door of the housing is open. As shown, the temperature control system may include a curtain. The curtain may be of solid construction, to reduce airflow therethrough. The curtain may therefore be plastic or rubber. The curtain may include a plurality of overlapping slats for easier ingress and egress by a user. The curtain may be configured to overlap and contact in a normal position to reduce airflow therethrough, but may be moved or separated by application of an outside force. Even when moved, the curtain is configured to reduce an opening of the interior space and reduce airflow therefrom or thereto. The bottoms of the curtain may be weighted to bias the curtain in a preferred position.

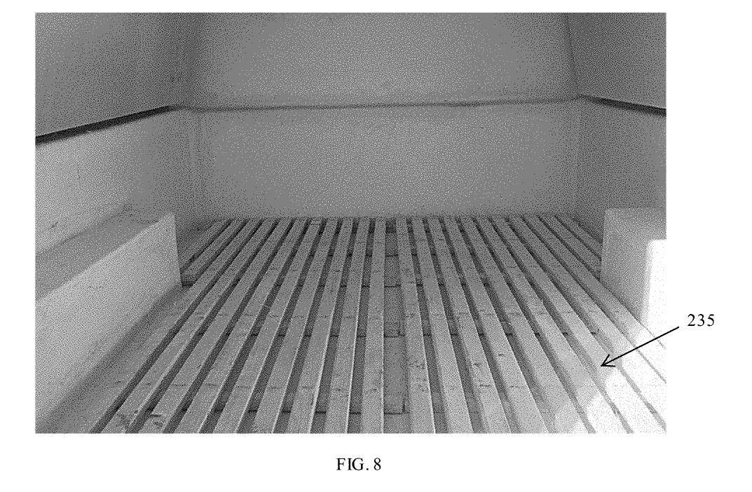

FIG. 8 illustrates an exemplary interior view of an exemplary embodiment of a cooler according to embodiments described herein. As shown in FIG. 8, the floor 235 may include apertures for permitting material and fluid to pass there through. In an exemplary embodiment, the floor may include raised slats. In this configuration, the floor may include a plurality of parallel bars that have gaps there between. The gaps may permit fluid flow there through. The bars may be separated from an interior surface of the floor.

As shown in FIG. 8, the interior cavity may include a stepwise projection defining a ledge within the interior thereof. The stepwise projection may be configured to provide space on the exterior surface of the housing for a wheel well or other contoured surface of the truck bed. The interior cavity may include a lower portion that is substantially vertical of approximately constant cross dimension. The interior cavity may include an upper portion that is substantially vertical that is of approximately constant cross dimension or of tapering cross dimension. Therefore, the upper portion may be tapered inward in a cross dimension between lateral sides.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. No single feature is considered essential or necessary to the invention. Instead, the invention includes exemplary features that may be used in one or more combinations are provided herein. The scope of the invention should be determined by the claims only, and not limited by the exemplary embodiments provided herein. The lengths and measurements provided herein are exemplary only. The overall size of the cooler may be reduced or enlarged such that the dimensions may scale for smaller and larger embodiments. The ranges are provided for simplicity and are meant to include every measurement, at least on a 0.001 increment between and inclusive of the identified endpoints. For example, a range of 0.001 to 0.004 would include each of 0.001, 0.002, 0.003, 0.004, and any combination thereof.

What is claimed is:

1. A device for dispensing a liquid, wherein the device comprises:
a housing; and
a liquid dispenser that is integrated into the housing,
wherein the housing is configured to hold a plurality of storage containers that contain a liquid, and the liquid dispenser is configured to mate with the storage container such that a fluid flow path is defined from an interior of the container to an exterior of the housing.

2. The device of claim 1, wherein an outer profile of the housing includes a reduced diameter lower portion and a stepwise transition to an upper portion such that the housing is configured to be mate with a bed of a truck.

3. The device of claim 2, wherein an exterior floor of the housing is configured to rest on an interior bottom surface of the bed of the truck, and a flanged surface defined by the stepwise transition is configured to rest on a perimeter rim of the bed of the truck.

4. The device of claim 3, wherein the liquid dispenser further comprises one or more tubes and one or more nozzles, and the one or more nozzles are located on an exterior surface of the housing, and the tubes are configured to carry liquid from the storage container to the nozzle.

5. The device of claim 4, further comprising a liquid collection system configured to receive fluid dispensed from the one or more nozzles and return the fluid to an interior of the housing.

6. The device of claim 4, wherein the housing comprises an insulated wall and the device does not include a powered refrigeration system.

7. The device of claim 6, wherein the insulated wall comprises a double walled insulation.

8. The device of claim 1, wherein an exterior surface of the housing is configured to approximately conform to the interior bed of a truck.

9. The device of claim 8, further comprising a door for providing access to an interior cavity defined by the housing.

10. The device of claim 9, wherein a diameter between opposing external lateral sides of the housing is less at a lower portion of the housing than at an upper portion of the housing.

11. The device of claim 10, wherein a transition between the lower portion to the upper portion defines a stepwise ledge configured to rest on a perimeter edge of a truck bed wall.

12. The device of claim 11, further comprising an extendable floor portion configured to move relative to the housing.

13. The device of claim 12, further comprising a retaining system configured to couple a storage container to the housing.

14. A device for dispensing a liquid, wherein the device comprises:
a housing enclosing an interior cavity and having a recess on an exterior surface on a side wall of the housing and a door permitting access to the interior cavity, the exterior surface of the housing having a step wise ledge shaped to correspond to a lip of a truck bed and a lower portion of the exterior surface configured to correspond and fit within an interior configuration of a truck bed;
a plurality of containers containing a liquid within the housing and removable from the housing;
a plurality of nozzles positioned within the recess on the exterior surface of the side wall of the housing;
a liquid dispensing system integrated into the housing and configured to create a plurality of separate fluid flow paths from each container of the plurality of containers within the housing to an exterior of the housing through each nozzle of the plurality of nozzles, wherein one nozzle corresponds to one container;
a retention system configured to reduce movement of the plurality of containers relative to the housing,
wherein the housing is comprises an insulation and the device does not include an electronic cooling system.
